(19) United States
(12) Patent Application Publication
(10) Pub. No.: US 2004/0090015 A1
(43) Pub. Date: May 13, 2004

(54) Sealing ring

(75) Inventors: Britta Weiss, Moerlenbach (DE); Rolf Stadler, Heppenheim (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Carl Freudenberg KG, Weinheim (DE)

(21) Appl. No.: 10/660,130

(22) Filed: Sep. 11, 2003

(30) Foreign Application Priority Data
Sep. 14, 2002 (DE) DE102 42 847.6-12

(51) Int. Cl. F16J 15/32

(52) U.S. Cl. 277/549

(57) ABSTRACT

A sealing ring, including a supporting ring made of resin which is joined to a lip ring of elastomeric material. Also a method for manufacturing a sealing ring, that includes introducing a resin into a first cavity of a tool and subsequently hardening the resin so as to fabricate a supporting ring, introducing an elastomeric material into a second cavity of the tool and extruding the elastomeric material onto the supporting ring so as to fabricate a lip ring, hardening the elastomeric material so as to bond the lip ring to the supporting ring thereby forming the sealing ring, and removing the sealing ring from the tool.

Priority is claimed to German Patent Application DE 102 42 847.6-12, filed on Sep. 14, 2002, the entire disclosure of which is incorporated by reference herein.

### BACKGROUND

The present invention is directed to a sealing ring including a supporting ring that is joined to a lip ring of elastomeric material.

Such sealing rings are generally known, the supporting ring being made of a metallic material, for example. To manufacture the sealing ring, it is first necessary to degrease and subsequently phosphatize the supporting ring that is made of a metallic material. The surface of the supporting ring is then coated with an adhesive agent to ensure an effective bonding to the elastomeric material of the lip ring.

### SUMMARY OF THE INVENTION

An object of the present invention is to further develop a sealing ring of the type mentioned at the outset so as to make it less complicated and less expensive to manufacture, and to make it lighter, and so as to eliminate the need for corrosion protection, as well as for a costly metal parts production for the supporting ring.

The present invention provides a sealing ring, comprising a supporting ring which is joined to a lip ring of elastomeric material, wherein the supporting ring (1) is made of a resin. The present invention also provides a method for manufacturing a sealing ring that includes, in a first method step, fabricating the supporting ring (1), resin being introduced into a first cavity and subsequently hardened. In a second method step, the method includes fabricating the lip ring (2), with elastomeric material being introduced into the tool, into a second cavity, and extruded onto the supporting ring (1). In a third method step, following hardening of the elastomeric material of the lip ring (2) and its bonding to the supporting ring (1) of resin, removing the ready-to-use sealing ring being from the tool.

The supporting ring is made of a resin. For example, an epoxide resin may be used. By using resin to fabricate the supporting ring, any desired form of the supporting ring may advantageously be easily manufactured, even when the ring has undercuts, for example. In its free-flowing state, resin is introduced into a tool cavity. The resin completely fills this tool cavity, and, once the resin is hardened, the supporting ring is ready for use. Another alternative provides for using prefabricated resin preforms that are inserted into the cavity. The resin preforms may be fabricated in a machining operation, for example.

In contrast to supporting rings of metallic materials, the use of supporting rings made of resin does not require any additional, complex or cost-intensive pretreatment procedures; the elastomeric material of the lip ring is bonded to the supporting ring without having to first degrease or phosphatize the supporting ring, or apply an adhesive agent thereto.

The supporting ring and the lip ring may preferably be integrally joined by vulcanization. This produces a permanent connection between the supporting ring and the lip ring that is inherent in the manufacturing process. Another variant provides for first vulcanizing the lip ring and subsequently joining it to the supporting ring, for example by bonding it thereto.

On the other hand, the supporting ring and the lip ring may also be joined to one another non-adhesively, preferably in a snap-fit connection. This simplifies the recycling of such sealing rings in that the sorting of the rings is facilitated.

Only comparatively little know-how is needed to manufacture and machine the above described supporting rings. The supporting rings made of resin are noncorroding and, in comparison to supporting rings of metallic materials, they have a smaller mass. This is particularly advantageous for applications requiring a small inertial mass.

The present invention is also directed to a method for manufacturing a sealing ring, wherein, in a first method step to fabricate the supporting ring, resin is introduced into a first cavity and subsequently hardened; in a second method step to fabricate the lip ring, elastomeric material is introduced into the tool, into a second cavity, and extruded onto the supporting ring; and, in a third method step, following hardening of the elastomeric material of the lip ring and its bonding to the supporting ring of resin, the ready-to-use sealing ring is removed from the tool. This manufacturing method combines the fabrication of the supporting ring with the forming of the lip ring; the entire sealing ring is manufactured in only one tool.

The present invention is also directed to a method for manufacturing a sealing ring, wherein in a first method step to fabricate the supporting ring, is being introduced into a first tool, into a first cavity, and subsequently hardened; in a second method step, the hardened supporting ring is inserted into a second tool; in a third method step to fabricate the lip ring, elastomeric material is introduced into the second tool, into a second cavity and extruded onto the supporting ring; and, in a fourth method step, following hardening of the elastomeric material of the lip ring and its bonding to the supporting ring of resin, the ready-to-use sealing ring is removed from the second tool.

The sealing ring according to the present invention is simple to produce, exhibits substantial stability and effective chemical resistance to most media to be sealed off, has considerable dimensional stability and accuracy to shape, and is also able to easily stored in areas of high atmospheric humidity, since the supporting ring made of resin is not hygroscopic.

### BRIEF DESCRIPTION OF THE DRAWINGS

Two exemplary embodiments of a sealing ring according to the present invention are described in greater detail in the following with reference to the drawings, in which:

FIG. 1 shows a first exemplary embodiment of a sealing ring in which an annular supporting ring is used; and

FIG. 2 shows a second exemplary embodiment similar to that of FIG. 1, the supporting ring having an angular design.

### DETAILED DESCRIPTION

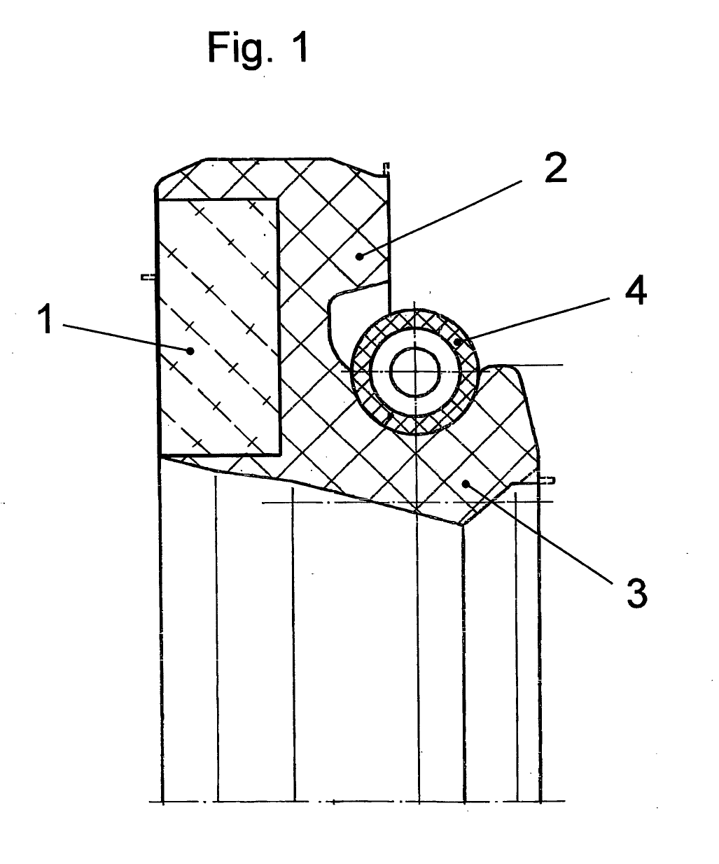

A first exemplary embodiment of a sealing ring according to the present invention is shown in FIG. 1. The sealing ring includes an annular supporting ring 1 which is made of epoxide resin. Lip ring 2 is made of an elastomeric material and, in this exemplary embodiment, has a sealing lip 3, which is pressed by an annular helical spring 4 radially inwardly against a machine element (not shown here), such as a shaft or a rod.

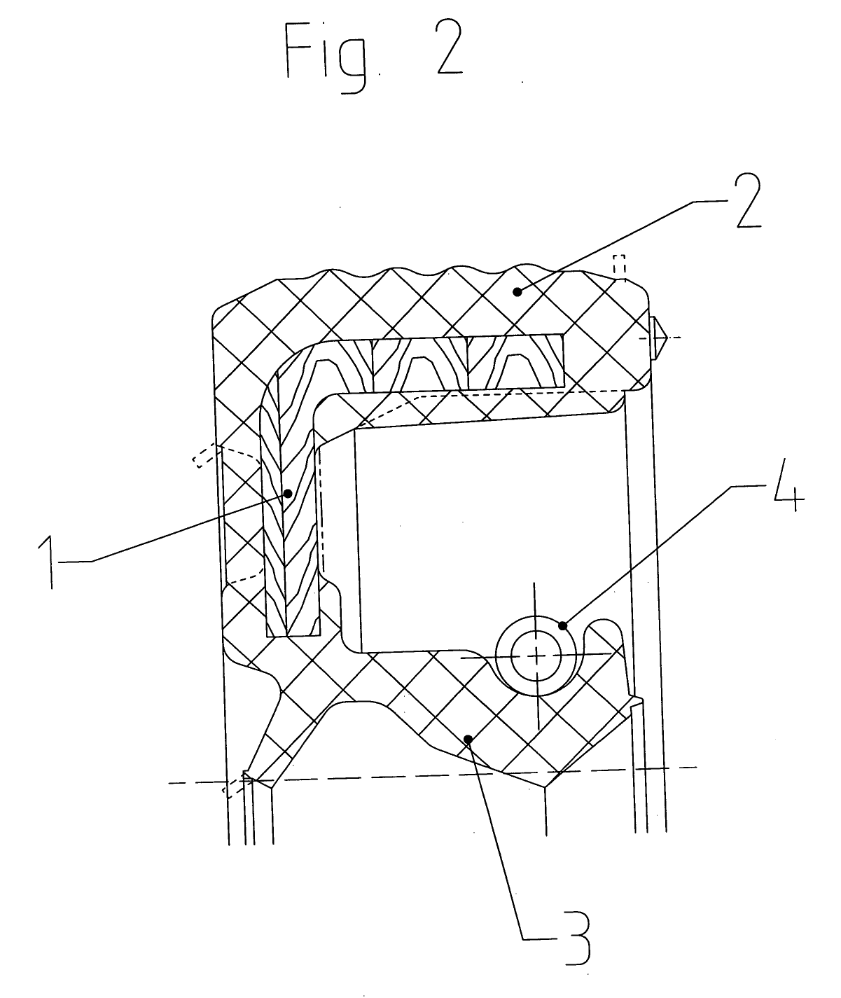

In FIG. 2, an exemplary embodiment is shown similar to that of FIG. 1, supporting ring 1 having an angular profile. In this exemplary embodiment as well, supporting ring 1 is made of epoxide resin.

What is claimed is:

1. A sealing ring, comprising:
a lip ring including an elastomeric material;
a supporting joined to the lip ring, the supporting ring including a resin.

2. The sealing ring as recited in claim 1, wherein the resin is made an epoxide resin.

3. The sealing ring as recited in claim 1, wherein the supporting ring and the lip ring are integrally joined by vulcanization.

4. The sealing ring as recited in claim 1, wherein the supporting ring is capable of being produced in one of a primary forming and a reforming process.

5. A method for manufacturing a sealing ring, comprising:
introducing a resin into a first cavity of a tool and subsequently hardening the resin so as to fabricate a supporting ring;
introducing an elastomeric material into a second cavity of the tool and extruding the elastomeric material onto the supporting ring so as to fabricate a lip ring;
hardening the elastomeric material so as to bond the lip ring to the supporting ring thereby forming the sealing ring; and
removing the sealing ring from the tool.

6. A method for manufacturing a sealing ring, comprising:
introducing a resin into a first cavity of a first tool and subsequently hardening the resin so as to create a hardened supporting ring;
inserting the hardened supporting ring into a second tool;
introducing the an elastomeric material into a second cavity of the second tool and extruding the elastomeric material onto the supporting ring so as to fabricate a lip ring;
hardening the elastomeric material so as to bond the lip ring to the supporting ring thereby forming the sealing ring; and
removing the sealing ring from the tool.
